(19) United States
(12) Patent Application Publication
(10) Pub. No.: US 2007/0121595 A1
(43) Pub. Date: May 31, 2007

(54) Method and apparatus for providing customized ringback to calling party devices in an IMS network

(76) Inventors: Ramachendra P. Batni, Phoenix, AZ (US); Stinson S. Mathai, Wheaton, IL (US); Darius J. Polikaitis, Downers Grove, IL (US); Ranjan Sharma, New Albany, OH (US); Robin J. Thompson, Batavia, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/290,228

(22) Filed: Nov. 30, 2005

(51) Int. Cl. H04L 12/66

(52) U.S. Cl. 370/356

(57) ABSTRACT

An exemplary method provides ringback information to a calling party device. A call establishment request is received in an Internet Protocol (IP) Multimedia Subsystem (IMS) network from the calling party device by a session initiation protocol, SIP, application server, SIP-AS. Ringback information associated with the called party, which may require condition evaluation such as time-of-day, day-of-week or may be unconditionally determined, is identified in response to the call establishment request. A push transmission technique is used by the SIP-AS to transmit the ringback information via one or more bearer packets sent from the SIP-AS to the calling party device.

### RELATED APPLICATION

This application is related to U.S. patent application Ser. No. 11/027,298 entitled “Method and Apparatus for Providing Multimedia Ringback Services to User Devices in IMS Networks”.

### BACKGROUND

This invention relates to telecommunication networks and, more specifically, to providing ringback services to user devices.

In a traditional wireline telephone system, ringback is the audio sound sent by a switch to the telephone of the calling party prior to call path connection to a called party. Such traditional ringback consisted of periodic tones used to convey to the calling party that the telephone of the called party was ringing.

Because an Internet Protocol (IP) Multimedia System (IMS) utilizes packet networks instead of traditional wireline circuit-based networks, ringback has to be generated and provided by other than a telecommunication switch. A known method of generating the ringback tones is local generation of the tones at the calling party equipment, upon receiving an appropriate signal from the network; however, the end-user's experience in such cases is limited to experiencing from one of the finite pre-stored ringback tones on the end-user device. Another known method of providing ringback in an IMS uses a Session Initiation Protocol (SIP) “Alert-Info” messaging. This functions as a client pull technique where the calling party is the client and the IMS is the network from which the ringback information is pulled by the client.

Multimedia ringback services where the ringback information includes other than normal audio content such as video, etc. is disclosed in U.S. patent application Ser. No. 11/027,298. This method requires substantial signaling and/or messaging among end user devices and network elements to provide such ringback service and also depends on a client pull for rendering multi-media contents.

### SUMMARY

It is an object of the present invention to provide an advance in ringback services.

An exemplary method provides ringback information to a calling party device. A call establishment request is received in an Internet Protocol (IP) Multimedia Subsystem (IMS) network from the calling party device by a session initiation protocol, SIP, application server, SIP-AS. Ringback information associated with the called party is identified in response to the call establishment request. A push transmission technique is used by the SIP-AS to transmit the ringback information via one or more messages sent from the SIP-AS to the calling party device.

A computer readable medium containing a software program, when executed by a computer, causes the computer to perform a method as generally described in the above exemplary method.

An exemplary session initiation protocol, SIP, application server, SIP-AS, is adapted to provide ringback information to a calling party device. It includes a mechanism for receiving a call establishment request from the calling party device. It identifies ringback information associated with the called party in response to said call establishment request. Further, it transmits the ringback information via one or more messages to the calling party device using a push transmission technique.

### DESCRIPTION OF THE DRAWINGS

Features of exemplary implementations of the invention will become apparent from the description, the claims, and the accompanying drawings in which:

FIG. 1 is a block diagram of an exemplary telecommunication system suited for incorporating an embodiment of the present invention.

FIG. 2 is a block diagram of an exemplary computing node suitable for performing the functions of the computing nodes of FIG. 1.

FIG. 3 is a signal flow diagram of an exemplary method according to an embodiment of the present invention.

### DETAILED DESCRIPTION

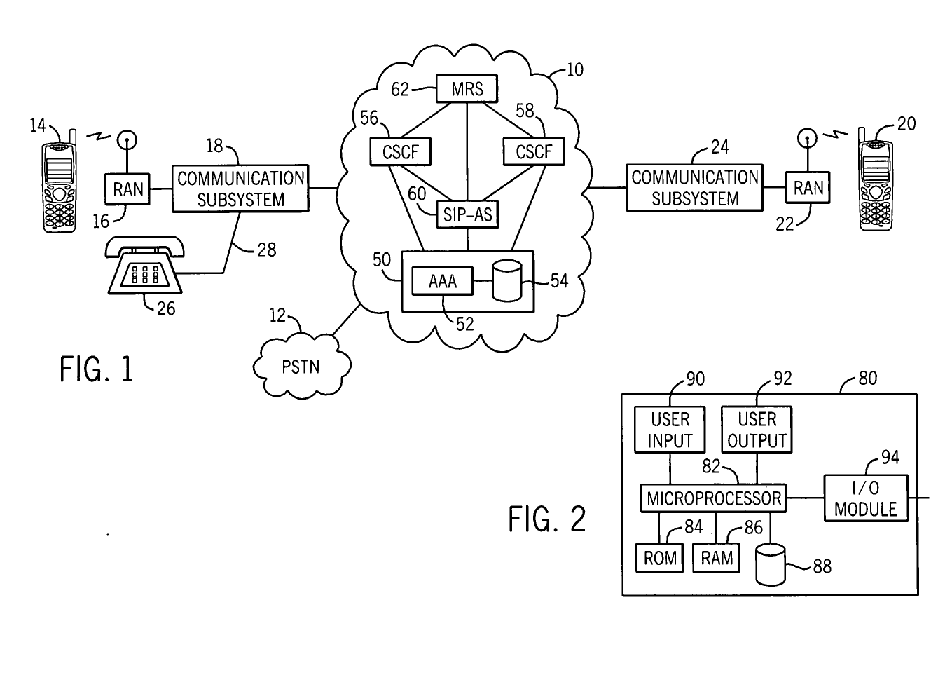

FIG. 1 shows a telecommunications system including an IMS network 10 that is connected to the public switched telephone network (PSTN) 12. A wireless communication device 14 is supported by a radio access node (RAN) 16. A communication subsystem 18 connects the RAN 16 and the IMS network 10, and supports communications with wireless device 14. Similarly, communications between another wireless communication device 20 and IMS network 10 is supported by RAN 22 and communication subsystem 24. Communications are also supported with another end-user communication device 26 that is connected by a communication path 28 with the communication subsystem 18 of IMS network 10. Depending upon the communication technologies employed, the communication subsystem 18 will be configured to support the corresponding technology and may comprise a packet data serving node (PDSN), a gateway general packet radio service (GPRS) support node (GGSN), a telecommunication switch or other network elements utilized to facilitate communications between the IMS network 10 and other access systems and/or end-user devices. Various access networks can be supported by the IMS 10. Such access networks may comprise a 3G wireless network such as supporting wideband code division multiple access (WCDMA), universal mobile telecommunications system (UMTS), code division multiple access (CDMA) 2000, a CDMA 2000 evolution data only (EvDO) system, a public switched telephony system (PSTN), an integrated services digital network (ISDN), and other such systems.

End-user devices comprise communication devices of telecommunications subscribers that can initiate and/or receive calls. Such end-user devices may comprise wireless communication devices such as cellular telephones, personal digital assistants, computers with wireless modems, etc. as well as wireline communication devices such as traditional telephones, IP telephones, SIP telephones, and computers and/or personal digital assistants connected by wireline.

The exemplary IMS 10 of FIG. 1 includes a home subscriber server (HSS) 50 that includes an authentication, authorization and accounting (AAA) server 52 and a subscriber database 54. The server 52 validates subscribers seeking access to the network, authorizes the use of requested communication services, and tracks services utilized by subscribers. Database 54 maintains and updates subscriber information such as account information, subscribed to subscription services, the model and/or capabilities of the subscriber's end-user device, etc. The HSS 50 is connected to call session control function (CSCF) servers 56 and 58. These servers provide SIP-based call control and call session handling functionality. For example, serving-CSCF, interrogating-CSCF, and proxy-CSCF functionalities can be provided by CSCF servers 56 and 58. A SIP application server (SIP-AS) 60 is connected to the CSCF servers 56, 58 and HSS 50, and provides support for initializing and maintaining an SIP communication link, e.g. a call, with an end-user device. A media resource server (MRS) 62 is coupled to SIP-AS 60 and CSCF servers 56, 58 and supports providing specialized ringback audio information to the calling party. The MRS 62 stores or has access to stored audio information selected by a subscriber so that upon the subscriber receiving a call, the selected audio information for the called subscriber can be retrieved and transmitted to the calling party as ringback information. The SIP-AS 60 keeps track of the per subscriber data including which users subscribe to the specialized ringback feature and which stored file of audio information is to be played under what circumstances.

FIG. 2 shows a computing node 80 generally suited for providing the functions associated with the servers and elements of FIG. 1. A microprocessor 82 is supported by read-only memory (ROM) 84, random access memory (RAM) 86 and nonvolatile memory 88 such as a hard disk drive. Stored control instructions in ROM 84 serve to initialize, i.e. boot, the computing node. The RAM 86 stores application instructions and data utilized by the microprocessor 82 in performing functions and tasks in accordance with the desired application. Typically the application program will be stored in nonvolatile memory 88 with at least selected portions of it being transferred to RAM 86 for access and processing by microprocessor 82. Depending upon the functionality to be achieved by the computing node, a user interface may be provided. For example, user input devices 90, e.g. keyboard, mouse, touch screen or pad, pointing device, etc., and user output devices 92, e.g. display screen, printer, external data storage device, etc., can be utilized depending upon the application and the anticipated inputs and outputs. It will be apparent that interface devices may be utilized between the microprocessor 82 and the inputs 90 and outputs 92 as needed. An input/output (I/O) module 94 is connected to microprocessor 82 and supports communications between the computing node 80 and external devices. Although only a single I/O module 94 is illustrated, it will be apparent that a plurality of such modules can be utilized to facilitate communications with different external devices and/or communication protocols.

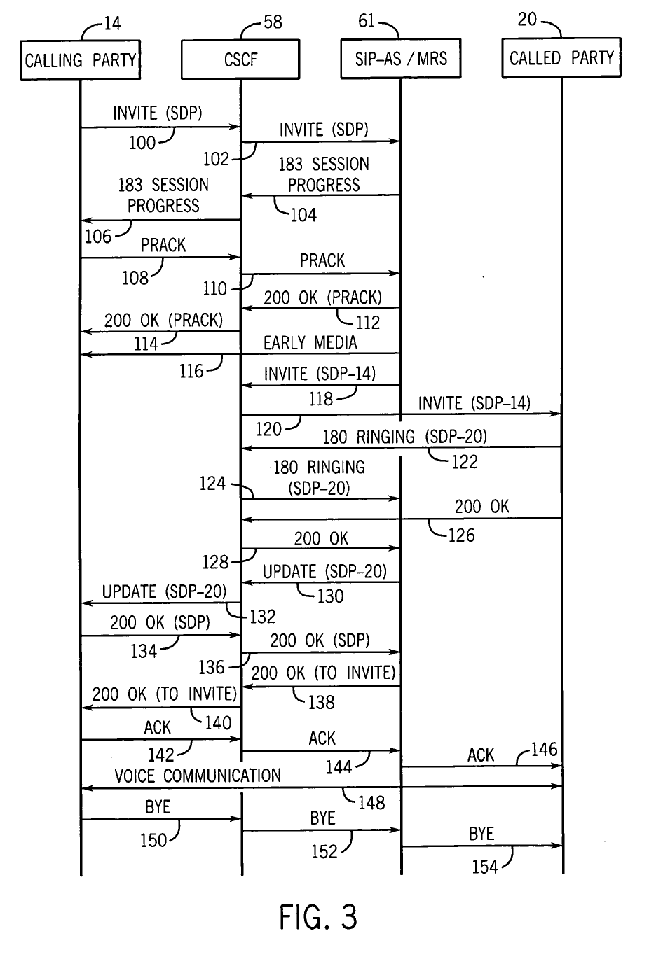

FIG. 3 is a signal diagram of an exemplary call flow method in which predetermined digital information, e.g. digitally stored audio, is provided to the calling party instead of conventional ringback tones. This signal diagram should be interpreted in conjunction with the exemplary architecture shown in FIG. 1. Signaling among a calling party device 14, CSCF 58, element 61 (SIP-AS 50 in combination with MRS 62) and the called party device 20 is shown in the context of a call initiated by the user of device 14 directed to the user of device 20. Although wireless devices 14 and 20 are utilized in this example, it will be understood that the device used by the calling and called parties could be any type of end-user device supported by a respective access system.

In step 100 the user of device 14 initiates a call to device 20 which is received by CSCF 56 functioning as a SIP proxy as an SIP INVITE containing associated session description protocol (SDP) information about device 14 which is in turn sent to CSCF 58. If the caller is in a legacy circuit network (PSTN) instead of the IMS (as shown), a Media Gateway (MGW) and Media Gateway Control Function (MGCF) act as the PSTN protocol to SIP interworking point and provides the SIP user agent interface to the IMS. In this example, CSCF 56 is assigned to support access systems including user device 14, and CSCF 58 is assigned to support access systems including user device 20. In step 102 CSCF 58 forwards the SIP INVITE to element 61 based on the initial filter criteria (IFC) for the called party, i.e. the user associated with device 20. Element 61 accesses the profile of the called party and determines based on stored control information in the profile that specialized ringback information is to be played to the calling party. Element 61 prepares to start streaming the stored audio information as ringback information to the calling party by sending a SIP 183 Session Progress message towards the calling party, i.e. by CSCF 58, in step 104. The CSCF 58 in turn transmits the SIP 183 Session Progress message to indicate that the initial portion of the session set up is successful and progressing to the calling party device 14 in step 106. The 183 Session Progress message contains an SDP in response to the SDP contained in the Invite 100,102. It is this exchange of SDP information between calling and called party devices that enables a real-time protocol (RTP) media session to be established as explained below. In response, the calling party device 14 transmits a provisional acknowledgment (PRACK) to CSCF 58 in step 108, which is relayed to element 61 in step 110. The PRACK acknowledges valid receipt of the SDP information in the 183 Session Progress message. The element 61 acknowledges receipt of the PRACK message by transmitting a 200 OK message to indicate that the PRACK was received to the CSCF 58 in step 112 which is in turn relayed to the calling party device 14 in step 114.

In accordance with step 116 element 61 transmits an SIP Early Media message stream including the specialized ringback information to device 14. This involves the SIP-AS 50 identifying and retrieving from MRS 62 the particular information, e.g. audio or other types of digital information, as predetermined by the called party. This information is transmitted by SIP-AS 50 as a stream of SIP Early Media packets to the calling party device 14 using IP network as the bearer. Although step 116 is illustrated following step 114, step 116 is concurrently processed and generated by element 61 following the receipt of the INVITE message at step 102, i.e. the SIP Early Media packets will be transmitted in parallel with the events associated with steps 104-114. For example, the calling party device 14 may receive a first SIP Early Media packet prior to the receipt of the SIP 183 Session Progress message indicated in step 106. This is specially the case when the signaling and bearer traffic follow different routes to the calling party device 14.

In step 118 element 61 initiates a call to the called party by sending a SIP INVITE message to CSCF 58 which relays this message in step 120 to the called party device 20. The SDP information carried in this message is the same SDP information received by element 61 with the INVITE message associated with step 102. Element 61, and in particular the SIP-AS 50, functions as a back-to-back end-user agent (B2BUA) in the illustrative embodiment. That is, in addition to element 61 terminating the call request (the INVITE message of step 102) from the user associated with device 14, it also serves to generate a new call request (INVITE message of step 118) directed to the called party device 20.

Assuming that the called party device 20 is free to accept the call, the called party device 20 responses in step 122 with a SIP 180 Ringing message transmitted to the CSCF 58 where the ringing message includes SDP information carrying the codec selected by device 20 as the best choice of the commonly acceptable codecs offered by device 14 and supported by device 20. That selected codec and respective port map are returned in the SDP in the 180 message in step 122. This information is relayed from CSCF 58 to element 61 in step 124. Similar to the PRACK (108, 110) and the 200 OK PRACK (112, 114), element 61 sends a PRACK to the user agent server on the called party device 20 and receives back a SIP 200 OK (PRACK) in response (not shown). This response acknowledges receipt of the SDP information prior to execution of step 126.

In step 126 called party device 20 goes off hook and causes a SIP 200 OK message to be transmitted to CSCF 58 which in turn relays the message to element 61 in step 128. Element 61 updates the session parameters from the value negotiated in the Early Media session (step 116) to reflect the session parameters received in the SDP information from device 20. The SIP UPDATE session parameters are transmitted from element 61 to CSCF 58 in step 130 and from CSCF 58 to device 14 in step 132. In step 134 device 14 transmits a 200 OK message (to confirm the codec negotiations via SDP) to CSCF 58 which in turn relays this message to element 61 in step 136. This permits the SDP parameters to be mutually agreed upon between devices 14 and 20, and thus permits the selection of a transmission protocol, e.g. codec algorithm, etc., that can be understood by both devices 14 and 20.

In step 138 element 61 sends a 200 OK (to invite) message to CSCF 58 which is relayed to device 14 in step 140. This is in response to the initial SIP INVITE message received in step 102. An acknowledgment (ACK) to the message received in step 140 is originated by device 14 and transmitted in steps 142, 144 and 146 to the CSCF 58, element 61 and device 20, respectively. This results in an end to end voice communication path between devices 14 and 20 being established as indicated in step 148. Note that prior to sending the 200 OK (to invite), billing for the call does not begin; in other words, the Early Media session that provides the specialized ringback tones does not incur any costs for the calling parties before the called party answers. It will be noted that this communication path actually consists of two linked communication paths: one communication path between device 14 and element 61, and another communication path between element 61 and device 20. Thus, element 61 (SIP-AS) functions as a B2BUA. It should also be noted that the Early Media messaging originated by element 61 has effectively morphed into a real-time communication path between the end-users.

In this example it is assumed that user of device 14 is the first to terminate the established communication path. Upon device 14 going on hook, a BYE message is originated by device 14 and transmitted in steps 150, 152 and 154 to CSF 58, element 61 and device 20, respectively. Acceptance of the BYE messages by CSF 58, element 61 and device 20 are confirmed by the transmission of responsive 200 OK (to BYE) messages to the respective sending elements (not shown). This effectively tears down the established communication path and releases the network elements that were supporting the communication path. Although not described, it will be apparent to those skilled in the art that the tear down of the establish communication path can be initiated by either the calling or called party.

It will be appreciated that SIP Early Media messages are sent from the IMS network as a “push” operation to the client/user as contrasted with a client/user “pull” operation that is utilized with SIP alert-info messaging. Although device 14 initiated a call request (steps 100, 102), no request was made by device 14 to receive the information conveyed by the Early Media messaging. Hence, the ringback audio information originated from the IMS network as part of the Early Media messaging constitutes a push operation to device 14. In general, from an end-user's perspective a push operation involves the receipt of information or at least the tendering of the information to the end-user without the end-user first having made a request for that information. In a pull operation the end-user must first request the specific information which is then acquired or pulled from a network. The push of early media to the calling party or SIP agent for the calling party (in the case where the calling party is in the legacy PSTN network) provides an advantage in terms of compatibility with systems that are designed to receive audible ringback in the bearer path as is currently supported in the legacy PSTN.

In accordance with the above-described embodiment, element 61 serves as a ringback platform and functions as a B2BUA. Accordingly, element 61 remains in the signaling path including the voice communication path until the call is terminated.

It will also be noted that the ringback platform uses the SIP UPDATE messaging to effectively change the established Early Media session into a real-time protocol (RTP) media session that supports voice conversation between the end-users.

Although exemplary implementations of the invention have been depicted and described in detail herein, it will be apparent to those skilled in the art that various modifications, additions, substitutions, and the like can be made without departing from the spirit of the invention. For example, certain steps may be arranged in a different order as long as the desired overall functionality is maintained. Various architectural elements can be combined into a single element if convenient or desired. For example, the role of the SIP-AS may be divided between a front-end and a back-end processing element. Similarly, responsibility for performing a function can be transferred to other elements. The embodiment of the present invention may be implemented in software and/or a combination of software and hardware. For example, the methods performed by SIP-AS and MRS can be performed by program control instructions loaded into memory 84, 86, 88 for access and execution by microprocessor 82. Therefore, such methods of the embodiments of the present invention can be stored on a computer readable medium or transmission carrier.

The scope of the invention is defined in the following claims.

We claim:

1. A method for providing ringback information to a calling party device, comprising:
receiving a call establishment request from said calling party device by a session initiation protocol , SIP, application server, SIP-AS, said call establishment request seeking the establishment of a call path between said calling party device and a called party device in an Internet Protocol (IP) Multimedia Subsystem (IMS) network;
identifying ringback information associated with the called party in response to said call establishment request; and
using a push transmission technique by the SIP-AS to transmit said ringback information via one or more messages sent from the SIP-AS to the calling party device.

2. The method of claim 1 wherein the one or more messages comprises at least one SIP Early Media message having the calling party device as a destination where at least a portion of said ringback information is contained in at least one SIP Early Media packet.

3. The method of claim 1 wherein the one or more messages carrying the ringback information is transmitted to the calling party device prior to any transmission of messages to the called party device based on receipt of the call establishment request.

4. The method of claim 1 further comprising the steps of:
receiving session description protocol, SDP, information about characteristics of the called party device by the SIP-AS;
transmitting a SIP update message to the calling party device where the SIP update message contains at least a portion of the SDP information of the called party device.

5. The method of claim 4 further comprising the step of receiving from the calling party device a reply message responding to receipt of the SIP update message where the reply message confirms a codec protocol to be used by both the calling and called parties.

6. The method of claim 1 further comprising the step of establishing a call communication path between the calling party device and the called party device via two separate paths: one path between the calling party device and the SIP-AS, and the other path between the SIP-AS and the called party device.

7. The method of claim 1 further comprising the step of operating the SIP-AS as a back-to-back user-agent transceiver where a first packet sent via the one path from the calling party device to the SIP-AS is retransmitted by the SIP-AS to the called party device over the other path.

8. A computer readable medium containing a software program, when executed by a computer, causes the computer to perform a method comprising:
receiving a call establishment request from said calling party device by a session initiation protocol , SIP, application server, SIP-AS, said call establishment request seeking the establishment of a call path between said calling party device and a called party device in an Internet Protocol (IP) Multimedia Subsystem (IMS) network;
identifying ringback information associated with the called party in response to said call establishment request; and
using a push transmission technique by the SIP-AS to transmit said ringback information via one or more messages sent from the SIP-AS to the calling party device.

9. The computer readable medium of claim 8 wherein the one or more messages comprises at least one SIP Early Media message having the calling party device as a destination where at least a portion of said ringback information is contained in at least one SIP Early Media packet.

10. The computer readable medium of claim 8 wherein the one or more messages carrying the ringback information is transmitted to the calling party device prior to any transmission of messages to the called party device based on receipt of the call establishment request.

11. The computer readable medium of claim 8 further comprising:
receiving session description protocol, SDP, information about characteristics of the called party device by the SIP-AS;
transmitting an SIP update message to the calling party device where the SIP update message contains at least a portion of the SDP information of the called party device.

12. The computer readable medium of claim 11 further comprising receiving from the calling party device a reply message responding to receipt of the SIP update message where the reply message confirms a codec protocol to be used by both the calling and called parties.

13. The computer readable medium of claim 8 further comprising establishing a call communication path between the calling party device and the called party device via two separate paths: one path between the calling party device and the SIP-AS, and the other path between the SIP-AS and the called party device.

14. The computer readable medium of claim 13 further comprising operating the SIP-AS as a back-to-back user-agent transceiver where a first packet sent via the one path from the calling party device to the SIP-AS is retransmitted by the SIP-AS to the called party device over the other path.

15. A session initiation protocol, SIP, application server, SIP-AS, adapted to provide ringback information to a calling party device, comprising:
means for receiving a call establishment request from said calling party device, said call establishment request seeking the establishment of a call path between said calling party device and a called party device;
means for identifying ringback information associated with the called party in response to said call establishment request; and
means for transmitting said ringback information via one or more bearer packets to the calling party device using a push transmission technique.

16. The SIP-AS of claim 15 wherein the one or more bearer packets comprises at least one SIP Early Media packet having the calling party device as a destination where at least a portion of said ringback information is contained in the at least one SIP Early Media packet.

17. The SIP-AS of claim 15 further comprising:
means for receiving session description protocol, SDP, information about characteristics of the called party device;
means for transmitting an SIP update message to the calling party device where the SIP update message contains at least a portion of the SDP information of the called party device.

18. The SIP-AS of claim 15 further comprising means for establishing a call communication path between the calling party device and the called party device via two seperate paths: one path between the calling party device and the SIP-AS, and the other path between the SIP-AS and the called party device.

19. The SIP-AS of claim 18 further comprising means for operating as a back-to-back user-agent transceiver where a first packet sent via the one path from the calling party device to the SIP-AS is retransmitted by the SIP-AS to the called party device over the other path.
